(19) United States
(12) Patent Application Publication
(10) Pub. No.: US 2002/0003119 A1
(43) Pub. Date: Jan. 10, 2002

(54) Road-rail crane

(75) Inventors: Ralf Rode, Schwalmtal (DE); Klaus Sprave, Kaarst (DE)

Correspondence Address: COHEN, PONTANI, LIEBERMAN & PAVANE, Suite 1210, 551 Fifth Avenue, New York, NY, 10176, US

(73) Assignee: Atecs Mannesmann AG

(21) Appl. No.: 09/854,016

(22) Filed: May 11, 2001

(30) Foreign Application Priority Data
May 12, 2000 (DE) 100 24 160.3
May 18, 2000 (DE) 100 25 206.0

(51) Int. Cl. B66C 23/72

(52) U.S. Cl. 212/301

(57) ABSTRACT

A road-rail crane includes a crane undercarriage with spreadable outriggers hinged to the undercarriage; a crane superstructure connected to the crane undercarriage with freedom of rotation, the luffing boom of the crane being mounted on the superstructure; and rail traveling gear attached to the crane undercarriage for rail travel. The crane undercarriage and the crane superstructure can be carried temporarily as a single transportable unit by a road transport means, which can be removed and then replaced by the rail traveling gear, which can be connected to the crane undercarriage, after the crane undercarriage has been supported and raised on the spread-out outriggers.

### BACKGROUND OF THE INVENTION

1. Field of the Invention

The invention pertains to a road-rail crane, consisting of a crane undercarriage mounted on road transport gear; spreadable outriggers hinged to the crane undercarriage; a crane superstructure, which is connected to the crane undercarriage with freedom to rotate, the luffing boom of the crane being mounted on the superstructure; and rail traveling gear attached to the crane undercarriage for traveling on the rails.

2. Description of the Related Art

to So-called road-rail vehicles for combination use on the road and on rails are known. The advantage of these machines is that the vehicle can start out on the road and then be put on the tracks in a relatively short time to move loads over the rails. A typical unit of this type is illustrated and described in the prospectus entitled “Demag Telescoping Crane AC 50R, On Road and Rail”. The known machine can be used either as a rail crane or as a telescoping road crane for the rescue of both rail and road vehicles; it can also lay track after traveling to the work site over the road. The machine has the driving behavior of a truck or of a streetcar and is suitable for a wide range of different applications.

The machine of the general type in question is equipped with front and rear rail bogies, which are permanently connected to the chassis of the crane vehicle but can be hydraulically raised and lowered. When the rail bogies are lowered, the crane vehicle is raised, so that the wheels lose contact with the ground. By means of a drive unit and a drive control system, which can be actuated from the driver's cab, the machine can then be driven like a streetcar. By raising the rail bogies again hydraulically, the machine comes to rest on its wheels again. After the rail bogies been lifted even farther, the machine can be driven off like a truck. The rail bogies remain on the vehicle at all times, however.

The known solution of a road-rail vehicle is suitable for relatively small and medium-sized loads or vehicle sizes, as long as it is possible for the road vehicle to drive to the section of track in question so that the rail bogies can be set down onto the rails. In the past, larger rail cranes could be transported to the work site only over the rails. This was a disadvantage in cases where, for example, rescue operations were to be performed on sections of track where an accident had occurred, but the end of the train to be rescued could not be reached because the rails were blocked. In such cases, the rail crane had to be driven on sidings around the blocked section. This meant the blocking of a significant section of track, the loss of much time, and considerable economic burden. The track-bound rail crane cannot 15 be broken down into parts and is too heavy to be transported by road vehicles.

### SUMMARY OF THE INVENTION

Against this background, the object of the present invention is to create a road-rail crane capable of handling heavy loads, which can be transported quickly and easily to the site of an accident or a construction site, and which can be positioned on the tracks precisely in a very short period of time. At the same time, a working method is also to be provided, by means of which the rail crane according to the invention can be converted from road travel to rail travel.

In accordance with the invention, the crane undercarriage and the superstructure can be set down temporarily as a single unit onto a road transport means. Thus, after the crane undercarriage has been supported and raised on the spread-out outriggers, the road transport means can be removed and then replaced by the rail traveling gear, which can be attached to the crane undercarriage.

A significant difference between the proposed solution and the known machine is that the rail traveling gear no longer has to be carried along with the crane; on the contrary, after the rail crane has been set down onto the road transport means, the crane is transported without the rail traveling gear.

In accordance with another feature of the invention, the road transport means can be a known towed low-loader, but it can also be one of the special self-powered vehicles which are on the market. The rail traveling gear can be transported on an escort vehicle, as a result of which the transport weight and the transport size of the rail crane are both reduced, and its transportability is considerably improved. The outriggers for the crane used during its operation are mounted so that they can be folded onto the crane undercarriage; attachment means are also provided on the crane undercarriage, to which the rail bogies can be quickly adapted.

The rail traveling gear is preferably divided into two parts; these parts are attached to opposite ends of the crane undercarriage.

In accordance with another feature of the invention, the crane is designed so that the contours of the rail crane, including the folded-in outriggers, remain within the allowable structure clearance for rail travel and within the allowable road transport dimensions for road travel. This feature permits the rail crane to travel quickly over the road without being subject to the traffic restrictions applicable to special travel by extra-wide vehicles; in addition, the rail crane can travel over the rails to the work site without the need to make modifications to it to achieve the prescribed structure clearance.

The rail traveling gear and possibly the counterweights of the rail crane are preferably transported on a separate transport vehicle, so that no limitations need to be imposed on the load capacity of the crane for the sake of its transport weight.

The particular advantage of the rail crane according to the invention is that it can be set up very quickly and precisely by the use of the process according to the invention, which is characterized by the following work steps:

(a) the rail crane is driven by a standard commercial road low-loader or by its own bolted-on road traveling gear across the section of track until the center of rotation of the superstructure is positioned over the center of the tracks;

(b) the outriggers are flipped out, and the rail crane is raised above the support cylinders of the outriggers as far as necessary to allow the road traveling gear to be disconnected and/or removed;

(c) the road traveling gear is disconnected and/or removed.

(d) the rail traveling gear is picked up and swung into position by a crane, and after the traveling gear has been set down onto the rails, it is connected to the crane undercarriage; and

(e) after the outriggers have been retracted and folded back in, the rail crane is driven along the rails to the work site.

The proposed process for putting the rail crane according to the invention onto the rails means that approximately one hour is all that is required between the time the crane arrives at the work site and the time it is set onto the rails, ready for duty. There is no need for any complicated repositioning work with external cranes; the tools for setting the crane onto the rails are carried along by the crane itself.

There are two different procedures which can be followed for setting up the rail crane. According to the first one, the rail crane is driven across the tracks in a crosswise orientation to them, such as at an angle of 90°, by the road low-loader or by means of its own bolted-on road traveling gear. For this purpose, the undercarriage of the rail crane is preferably set in such a way on the low loader that the attachments for the rail traveling gear(s) are oriented in the same direction as the rails. The crane can thus be set down on the rails at a rail crossing, for example, across which the road low-loader has driven until the center of rotation of the superstructure of the crane is positioned in the middle of the tracks. In this position, the outriggers can be extended, and the undercarriage can be raised along with the superstructure far enough off the low-loader that the low-loader can be driven or pulled out from underneath. After the rail traveling gear has been attached to the attachment points provided on the undercarriage, it is lowered together with the undercarriage and the superstructure onto the tracks; and after the outriggers have been folded in, the rail crane is ready to travel along the rails.

The other procedure for setting the crane onto the tracks consists in having the low-loader or the bolted-on road traveling gear drive the rail crane over the desired section of track with a parallel orientation to the tracks. Preferably in this case the attachments for the rail traveling gears to the undercarriage are again parallel to the direction of the rails; in this case, therefore, they would be oriented in the direction of the longitudinal axis of the low-loader. The rest of the procedure for setting the crane onto the rails is the same as that described above.

In accordance with another feature of the invention, it is logical to use the rail crane's own boom to pick up, to swing into position, and to set down the rail traveling gear onto the rails.

The ability to position the crane precisely can be improved if desired by providing the bases of the crane outrigger system with integrated devices for sliding the support cylinders crosswise to the outrigger bases.

The particular advantage of the present invention can be described in summary as follows: the rail crane, which is ready for duty except for its rail traveling gear, can be transported on a standard commercial road low- loader or by means of its own bolted-on road traveling gear in either a transverse or longitudinal orientation to the desired section of track until its center of rotation is centered over the tracks. After the outriggers have been flipped out, the rail crane is raised by the support cylinders until the low-loader can be driven out from underneath the crane or until the bolted-on road traveling gear can be disconnected from the undercarriage. Then the rail traveling gear, which has preferably been transported separately, is lifted by the crane's own hook from the accompanying truck and swung over to the quick adapters of the undercarriage and attached there. As a result, the shortest possible setup time is achieved. The transport weight and transport dimensions allow rapid and easy transport of even large rail cranes to the work site.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1A is a sideview of a rail crane according to the invention for over-the-road transport;

FIG. 1B is a plan view of the rail crane;

FIG. 2 shows the process of setting the crane down on the tracks in the case where the road transport means is crosswise to the tracks;

FIG. 3 shows the rail traveling gear being picked up; and

FIG. 4 shows the rail crane after it has been set down onto the tracks.

### DETAILED DESCRIPTION OF THE PRESENTLY PREFERRED EMBODIMENTS

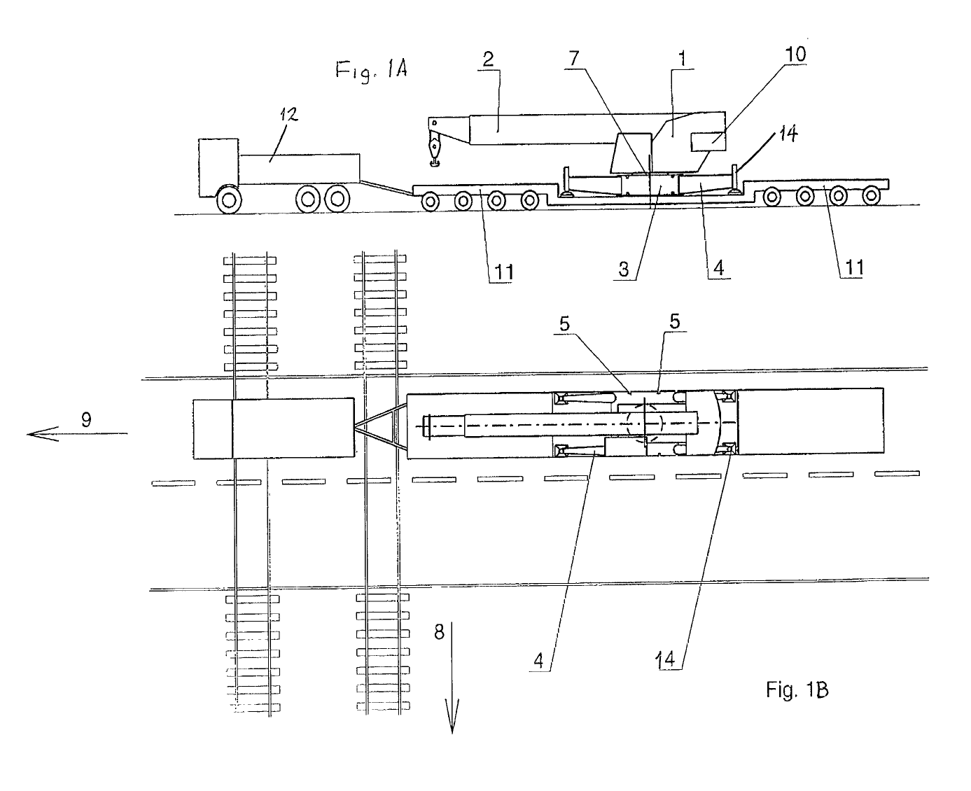

The rail crane according to FIG. 1 consists of the crane superstructure 1 with the telescoping boom 2 and the crane undercarriage 3. The folding outriggers 4 are hinged to the crane undercarriage 3; quick adapters 5 are also provided on the undercarriage, to which the rail traveling gears 6 to be described later are attached. The superstructure and the undercarriage of the crane are connected to each other by a rotary joint 7 in such a way that the upper carriage can rotate without restriction. The undercarriage 3 is designed so that it can be transported over the road 9. For this purpose, the outriggers 4 can be folded in so that they point in the travel direction and do not project beyond the contours of the road transport A) vehicle 11. In the example shown, the crane counterweight 10 remains on the superstructure 2 while the crane is traveling over the road; if weight is a problem, the counterweight can also be transported by a separate vehicle.

The individual phases of the procedure for setting the rail crane onto the tracks are described below.

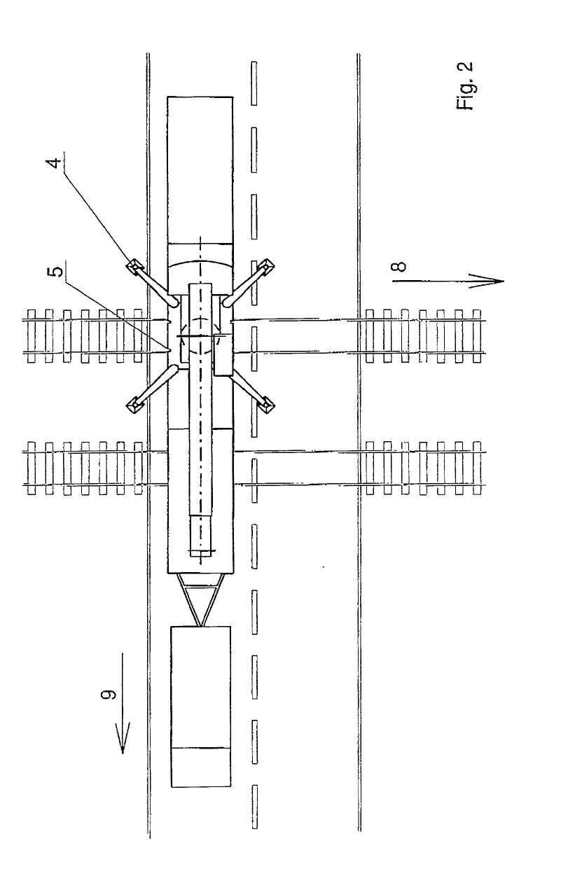

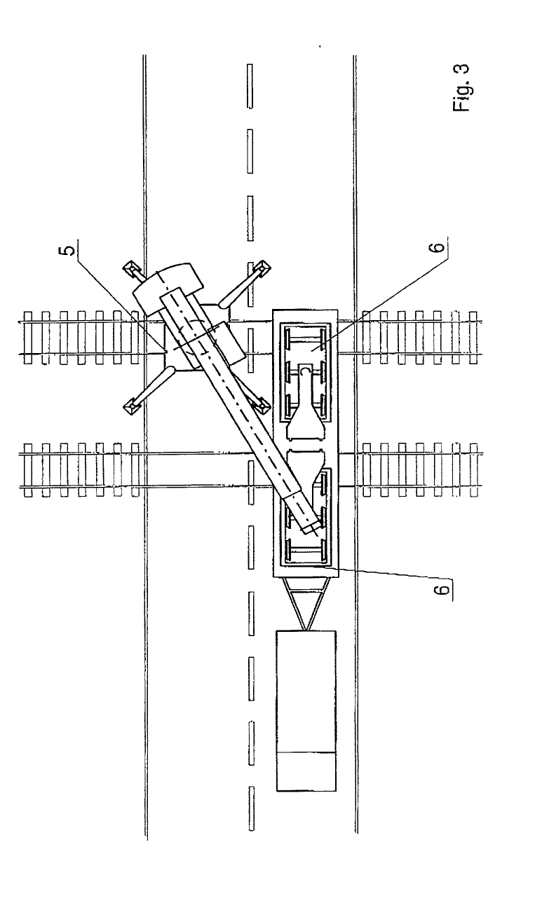

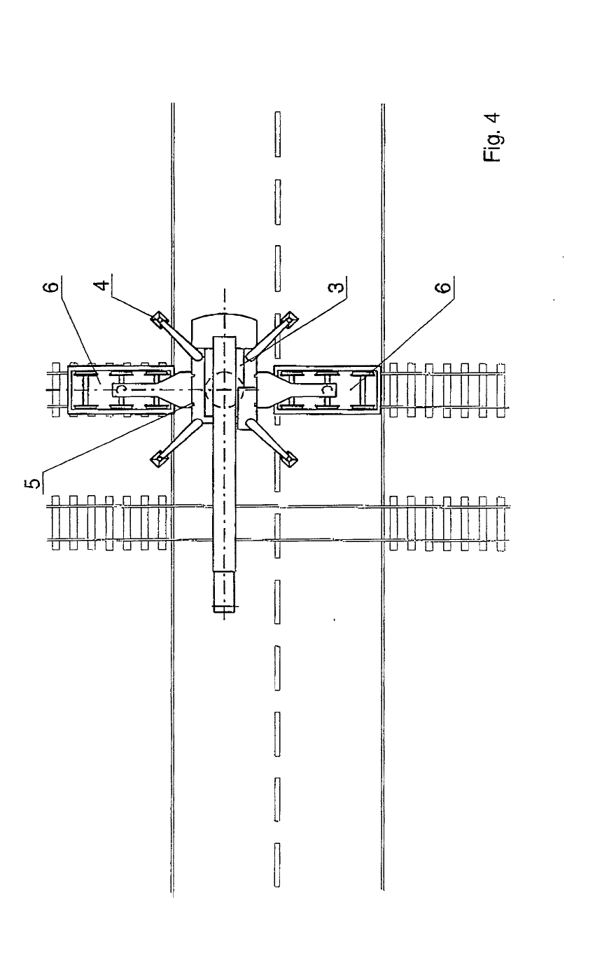

As FIG. 2 indicates, the trailer 11, carrying the rail crane but not the rail traveling gears 6, drives to the area of a rail crossing, where the rail travel direction 8 and the road travel direction 9 intersect. The tow vehicle 12 drives the trailer 11, designed here as a low-loader, far enough across the tracks that the center of rotation of the superstructure 1 is positioned over the center of the tracks. In this position, the outriggers 4 are extended by about 45° to the longitudinal center plane of the rail crane. The outriggers 4 are set down onto the ground by means of the support cylinders 14, and the rail crane is then lifted from the low-loader. By extending the support cylinders even farther, the rail crane is raised to a height which allows the low-loader to be pulled out from underneath. By slewing the superstructure 1 and by luffing or extending the telescoping boom 2, the rail crane, which is now supported on its outriggers, can pick up the rail traveling gears 6, which are resting on an escort vehicle (FIG. 3), with its own crane hook. In the example here, two rail bogies 6 are present, one of which is set down at each end of the undercarriage 3 of the rail crane. For this purpose, the boom 2 of the rail crane picks up each of the rail bogies 6 separately and swings them over the tracks. Once there, they are moved up to the undercarriage 3 and attached to it at adapters 5. As soon as the rail bogies 6 have been attached to the crane undercarriage 3, the undercarriage A)to can be set down onto the tracks, as illustrated in FIG. 4. After the boom 2 has been swung back into a position parallel to the tracks and the outriggers 4 have been folded back into a position parallel to the longitudinal axis of the undercarriage 3, the rail crane is ready to travel over the rails to any desired work site.

The procedure described above for setting the crane onto the tracks can also be realized by driving the low-loader in the same direction as that of the rails 8 until the center of the tracks is reached. The rest of the procedure is the same as that described above; this crane-setting method assumes merely that the undercarriage 3 must be transported in the same direction as it will travel on the rails; that is, the quick adapters 5 for the rail bogies 6 must be oriented in the direction opposite perpendicular to that of the road travel direction.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A road-rail crane comprising
a crane undercarriage;
a crane superstructure rotatably mounted on said undercarriage;
a luffing boom mounted on the superstructure;
spreadable outriggers hinged to the undercarriage, each said outrigger comprising support means for supporting said undercarriage and raising said undercarriage relative to a road surface; and
rail travelling gear which can be connected to the crane undercarriage after said outriggers have been spread and said undercarriage has been supported and raised on the spread-out outriggers, whereby,
said crane can be transported by road transport means to a set of rails, said crane can be lifted so that said road transport means can be removed, and said crane can then be placed on said rail travelling gear.

2. A road-rail crane as in claim 1 wherein said undercarriage can be supported by road transport means comprising a standard commercial low-loader trailer.

3. A road-rail crane as in claim 1 further comprising quick adapters for connecting said rail travelling gear to said undercarriage.

4. A road-rail crane as in claim 1 said rail travelling gear comprises two bogies on which said undercarriage is supported.

5. A road-rail crane as in claim 1 wherein, when the outriggers are retracted, the crane has a profile which is within the allowable clearance for rail travel and within the allowable clearance for road travel.

6. A road-rail crane as in claim 1 wherein the superstructure comprises a counterweight which is removable for separate transport.

7. A method for setting up a road-rail crane at a work site on a pair of railroad tracks, said method comprising
providing a crane having an undercarriage, a crane superstructure rotatably mounted on said undercarriage, a luffing boom mounted on the superstructure, and spreadable outriggers hinged to the undercarriage, each said outrigger comprising support means for supporting said undercarriage and raising said undercarriage relative to a road surface;
transporting said crane by a standard commercial low-loader to a set of railroad tracks;
centering the center of rotation of said superstructure over the center of said tracks;
folding out the outriggers and raising the undercarriage on the support means so that the low-loader can be removed;
removing the low-loader;
positioning rail traveling gear on said tracks;
connecting said undercarriage to said rail travelling gear;
retracting said outriggers; and
transporting said rail crane on said tracks to a work site.

8. A method as in claim 7 wherein said crane is moved transversely to said tracks by said low-loader.

9. A method as in claim 7 wherein said crane is moved parallel to said tracks by said low-loader.

10. A method as in claim 7 wherein said rail travelling gear is positioned on said tracks by using the luffing boom to pick up the rail travelling gear, swing it into position over the tracks, and set it down onto the tracks.
